(19) United States
(12) Patent Application Publication
(10) Pub. No.: US 2003/0232559 A1
(43) Pub. Date: Dec. 18, 2003

(54) Vinyl chloride/vinyl acetate/ethylene/self-crosslinking polymers for non-cellulosic based substrates

(76) Inventors: Joel Erwin Goldstein, Allentown, PA (US); Jeffrey Allen Welty, Hellertown, PA (US); Deborah Ann Matelan, Emmaus, PA (US)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 10/174,315

(22) Filed: Jun. 17, 2002

(51) Int. Cl. B32B 5/18; B32B 5/24; C08L 33/00

(52) U.S. Cl. 442/374; 524/556

(57) ABSTRACT

The invention relates to an improvement in adhesive polymeric binders for nonwoven products and to the nonwoven product. The basic polymeric binder is comprised of emulsion polymerized units of vinyl acetate, ethylene and self-crosslinking monomer(s), e.g., N-methylol acrylamide. The improvement in the adhesive polymeric binder for forming nonwoven webs comprised largely of synthetic fibers resides in the presence of vinyl chloride polymerized into the vinyl acetate/ethylene polymer backbone.

### BACKGROUND OF THE INVENTION

Nonwoven products for the preparation of absorbent, disposable products such as wipes have been widely practiced. Such nonwoven products or fabrics are comprised of loosely assembled webs or masses of fibers bound together with an adhesive polymeric binder. These fibers have been comprised of cellulosic or polymeric materials such as polyesters, polyamides, polyacrylates and the like. Many of the adhesive polymers for non woven webs have been based upon water-based polymers of vinyl acetate, ethylene and a self crosslinking mechanism, e.g., N-methylol acrylamide (NMA) or equivalent formed by emulsion polymerization The incorporation of a self crosslinkng mechanism provides for enhanced wet strength and resistance to organic solvents.

The following patents are representative of the art:

U.S. Pat. No. 3,380,851 discloses a nonwoven binder comprised of a polymer of vinyl acetate, another polymerizable compound as an internal plasticizer, and a post-curable comonomer such as N-methylol acrylamide bonded to loosely assembled fibers. A wide variety of fibers based upon natural and synthetic fibers which include cellulose, wool, polyamides, polyesters, polyethylene and so forth are disclosed.

U.S. Pat. No. 4,449,978 discloses nonwoven webs of the type disclosed in U.S. Pat. No. 3,380,851 bonded with low formaldehyde generating adhesive polymers. Specific systems are based upon vinyl acetate, ethylene and a blend of acrylamide and N-methylol acrylamide.

U.S. Pat. No. 3,758,429 discloses adhesive binders based upon terpolymers of ethylene, vinyl chloride and N-methylol acrylamide for use in producing nonwoven webs. The terpolymers are provided to enhance wet strength.

U.S. Pat. No. 3,752,733 discloses nonwoven products based upon fibers from both natural and synthetic sources bonded with an ethylene/vinyl chloride/acrylamide terpolymer. The patentees disclose curing these polymers with sulfur compounds to provide increased tensile strength, softness, flexibility and so forth.

U.S. Pat. No. 3,137,589 discloses binders comprising a copolymer of an alpha, beta-unsaturated carboxylic acid amide substituted on the nitrogen by at least one methylol group and another unsaturated polymerizable compound for use in preparing nonwoven webs.

A disadvantage of the vinyl acetate/ethylene based adhesives of the prior at is the lack of adhesion to synthetic, non-cellulosic based webs and, therefore, the ability to provide good wet tensile strength. Apparently, because there are no reactive sites, or in many cases few reactive sites, relative to cellulose, which are capable of reacting with standard self-crosslinking vinyl acetate/ethylene based polymers, it is difficult to obtain finished webs with good wet tensile and solvent strength.

### SUMMARY OF THE INVENTION

The invention relates to an improvement in adhesive polymeric binders for nonwoven products and to the nonwoven product. The basic polymeric binder is comprised of polymerized units of vinyl acetate, ethylene and self-crosslinking monomer(s), e.g., N-methylol acrylamide, the polymeric binder formed by emulsion polymerization and formulated for forming nonwoven products. The improvement in the adhesive polymeric binder for forming nonwoven webs comprised largely of synthetic fibers resides in the presence of vinyl chloride polymerized into the vinyl acetate/ethylene polymer backbone.

Significant advantages are possible and these include:

enhanced adhesion to synthetic fibers which are substantially free of reactive sites, e.g., hydroxyl functionality;

an ability to use conventional equipment for nonwoven web preparation employing existing self-crosslinking vinyl acetate/ethylene binder systems without major capital expenditure for the changeover; and,

an ability to reduce the level of free formaldehyde through the use of reduced binder levels at equivalent strength.

Summarizing, the chief advantage of this binder system is that the polymeric binder exhibits improved adhesion to synthetic fibers thereby allowing for many new structures in nonwovens. This increased adhesion results in webs of higher strength than are commercially possible using any other known vinyl acetate/ethylene based binder system and allowing for manufacturing structures with equivalent strength to those currently commercially available using less binder. This latter advantage is not only a raw material savings but can also be a performance advantage as it would provide a finished product with a lower formaldehyde level, less streaking, improved absorbency as well as softer hand.

### DETAILED DESCRIPTION OF THE INVENTION

The invention relates to improved water-based vinyl acetate/ethylene polymers formed by emulsion polymerization for use as binders for nonwoven webs. The nonwoven webs include, synthetic, non-cellulosic based fibers as a component of the nonwoven web. The improved backbone of the polymer is comprised of polymerized units of vinyl acetate, vinyl chloride and ethylene with a limited amount of self-crosslinking monomer(s) incorporated into the polymer. The self-crosslinking monomers employed in the formation of the improved binders generally are based upon N-methylol derivatives, e.g., N-methylol acrylamide. C1-C5 alkoxysubstituted acrylamides such as N-methoxymethyl acrylamide and isobutoxymethyl acrylamide also may be used.

The composition of the improved polymer is similar to those vinyl acetate/ethylene based adhesives suited for nonwoven webs in the past with the exception of the incorporation of polymerized units of vinyl chloride. The vinyl acetate will range from 60 to 90 wt %, preferably from 70 to 80 wt %, the ethylene from 5 to 40 wt %, preferably from 10 to 25 wt %, the vinyl chloride from 5 to 40 wt %, preferably from 10 to 25 wt %, and the self-crosslinking monomer(s), such as N-methylol acrylamide, from 2-10 wt %, preferably from 3 to 8 wt %, based on the total weight of monomers in the polymer. For polymers of reduced free formaldehyde emissions, the preferred polymer contains from about 3 to 10 wt % of a mixture of N-methylol acrylamide/acrylamide. Preferably the N-methylol acrylamide at about 1.75 to 3.5 wt % and the acrylamide at about 1.25 to 8.25 wt % is employed in the formulation of the polymer. Contemplated as functional equivalents to N-methylol acrylamide, the acrylamide monomers are present in a N-methylol acrylamide:acrylamide molar ratio which is about 1:1; i.e., about equimolar.

In forming the improved polymers, vinyl acetate, ethylene, vinyl chloride and N-methylol acrylamide or an N-methylol acrylamide/acrylamide monomer mixture are copolymerized in an aqueous medium under pressures not exceeding 100 atmospheres in the presence of a catalyst and at least one emulsifying agent, the aqueous system being maintained by a suitable buffering agent at a pH of 2 to 6, the catalyst being added incrementally. The process is a batch process which involves first a homogenization in which the vinyl acetate suspended in water is thoroughly agitated in the presence of ethylene under the working pressure to effect solution of the ethylene in the vinyl acetate while the reaction medium is gradually heated to polymerization temperature. The reaction temperature can be controlled by the rate of catalyst addition and by the rate of the heat dissipation. Generally it has been found that it is advantageous to maintain a mean temperature of about 50° C. during the polymerization of the monomers and to avoid temperatures much in excess of 80° C.

The homogenization period is followed by a polymerization period during which the catalyst, which consists of a main catalyst, or initiator, and may include an activator, is added incrementally. The vinyl chloride and N-methylol acrylamide or an N-methylol acrylamide/acrylamide mixture are similarly added incrementally, the pressure in the system being maintained substantially constant by application of a constant ethylene pressure.

Various free-radical forming catalysts can be used in carrying out the polymerization of the monomers, such as peroxide compounds. Combination type catalysts employing both reducing agents and oxidizing agents can also be used. The use of this type of combined catalyst is generally referred to in the art as “redox polymerization” or “redox system.” The reducing agent is also often referred to as an activator and the oxidizing agent as an initiator. Suitable reducing agents or activators include bisulfites, sulfoxylates, Bruggolite FF-6 (a reducing agent sold by Bruggemann), ascorbic or erythorbic acid or other compounds having reducing properties such as ferrous salts, and tertiary aromatic amines, e.g. N,N-dimethylaniline. The oxidizing agents or initiators include hydrogen peroxide, organic peroxides such as benzoyl peroxide, tert-butyl hydroperoxide (t-bhp) and the like, persulfates, such as ammonium or potassium persulfate, perborates, and the like. Specific combination type catalysts or redox systems which can be used include t-butyl peroxide and zinc formaldehyde sulfoxylate or erythorbic acid; hydrogen peroxide, ammonium persulfate, or potassium persulfate, with sodium metabisulfite, sodium bisulfite, ferrous sulfate, dimethylaniline, zinc formaldehyde sulfoxylate or sodium formaldehyde sulfoxylate. Other types of catalysts that are well known in the art can also be used to polymerize the monomers.

The catalyst is employed in an amount of 0.1 to 2%, preferably 0.25 to 0.75% based on the weight of vinyl acetate introduced into the system. The activator is ordinarily added in aqueous solution and the amount of activator is generally 0.25 to 1 times the amount of catalyst.

The emulsifying agents which are suitably used are typically anionic, nonionic, or blends thereof. Suitable nonionic emulsifying agents include polyoxyethylene condensates. Polyoxyethylene condensates may be represented by the general formula: R—(CH₂CH₂O—)ₙH where R is the residue of a fatty alcohol containing 10 to 18 carbon atoms, an alkylphenol, a fatty acid containing 10 to 18 carbon atoms, an amide, an amine, or a mercaptan, and where n is an integer of 1 or above. Suitable anionic emulsifying agents include the monovalent salts of the sulfates of the above mentioned nonionics, mono or disodium salts of sulfosuccinates half esters or diesters, sodium salts of alkylbenzene sulfonates. A single emulsifying agent can be used, or the emulsifying agents can be used in combination. When combinations of emulsifying agents are used, it is advantageous to use a relatively hydrophobic emulsifying agent in combination with a relatively hydrophilic agent. A relatively hydrophobic agent is one having a cloud point in 1% aqueous solution below 190° F. (88° C.) and a relatively hydrophilic agent is one having a cloud point in 1% aqueous solution of 190° F. (88° C.) or above. The concentration range of the total amount of emulsifying agents useful is from 0.5 to 5% based on the aqueous phase of the latex regardless of the solids content. The surfactant package is typically used in an amount of from 2 to 7 wt % of the emulsions.

If it is desired to maintain the pH of the system at a desired value, there may suitably be added an alkaline buffering agent of any convenient type which is compatible with the stabilizing agent. The amount of buffer is generally about 0.1 to 0.5 wt % based on the monomers.

The reaction is generally continued until the residual vinyl acetate content is below 0.5%. The completed reaction product is then allowed to cool to about room temperature while sealed from the atmosphere. The pH is then suitably adjusted to a value in the range of 4.5 to 7, preferably 6 to 6.5, to insure maximum stability.

Latexes of relatively high solids contents can be directly produced and thus the products generally have solids contents of 55 to 65%. They can, of course, be easily thinned by the addition of water to lower solids contents of any desired value.

The vinyl acetate/ethylene/vinyl chloride/N-methylol acrylamide polymeric binder is used to prepare nonwoven products, or fabrics, by a variety of methods known to the art which, in general, involve the impregnation of a loosely assembled mass of fibers with the binder latex, followed by moderate heating to dry the mass. In the case of the present invention, this moderate heating also serves to cure the binder by forming a crosslinked polymer. Before the binder is applied it is, of course, mixed with a suitable catalyst of the N-methylol acrylamide. Thus, acid catalysts such as mineral acids, e.g. hydrogen chloride, or organic acids, e.g. oxalic acid, or acid salts such as ammonium chloride, are suitably used as known in the art. The amount of catalyst is generally about 0.5 to 2% of the total polymer.

The amount of binder, calculated on a dry basis, applied to the fibrous starting web should be at least about 2.5 wt % and suitably ranges from about 10 to about 50% or more by weight of the starting web, preferably from about 5 to about 25% by weight of the starting web. The impregnated web is then dried and cured. Thus the fabrics are suitably dried by passing them through an air oven or the like and then through a curing oven. Typical conditions to achieve optimal crosslinking are sufficient time and temperature such as drying at 150 to 200° F. (65 to 94° C.) for 4 to 6 minutes, followed by curing at 300 to 310° F. (149 to 155° C.) for 3 to 5 minutes or more. However, other time-temperature relationships can be employed as is well known in the art, shorter times at higher temperatures or longer times at lower temperatures being used.

The synthetic fibers employed for nonwoven web formation with the vinyl acetate/ethylene/vinyl chloride based polymers include polyester, polyethylene, polypropylene, polyacrylate, and polyamide fibers. Webs comprised of polyethylene and polyester fibers have shown significant improvement in wet tensile strength when the improved binders are employed. It has even been looked at in webs where most of the fibers are cellulosic but that there is about 10 to 20% synthetic fiber incorporated into the web. Generally, the web is formulated predominately of synthetic fibers, typically at least 90% of the entire web.

The following examples are provided to illustrate the invention and are not intended to restrict the scope thereof:

### EXAMPLE 1

### Vinyl Acetate/Ethylene/Vinyl Chloride/N-Methylol Acrylamide Polymer

To a one gallon pressure reactor was charged 800.0 g of deionized water, 305 g of Polystep COP-3S surfactant, a 20% aqueous solution of a 65:35 blend of sodium octyl phenol ethoxylate sulfonate and octyl phenol ethoxylate made by Stepan, 0.91 g of sodium acetate, 3.11 g of acetic acid, 2.3 g of a 5% aqueous solution of ferric ammonium sulfate and 312.0 g of vinyl acetate. The reactor was purged with nitrogen, agitated to 900 rpm and the temperature adjusted to 50° C. Ethylene (240 g) was charged into the reactor as was 15.0 g of a solution of 15% aqueous sodium formaldehyde sulfoxylate. A 3% aqueous solution of t-bhp was started at 0.5 ml/min. At initiation of the reaction, 934.4 g of vinyl acetate was added at 5.2 g/min, 311.6 g of vinyl chloride was added at 1.73 g/min and 324.0 g of a 30% aqueous solution of N-methylolacrylamide (NMA) was added at 1.35 g/min. An additional 100.0 g of ethylene was added over the course of the monomer delay that took a total of three hours to complete. After an hour, an aqueous delay of 15% aqueous sodium formaldehyde sulfoxylate was added to the reactor at a rate to maintain a ratio of 2.5:1 of active sodium formaldehyde sulfoxylate to active t-bhp. The residual monomers were converted using more of the aqueous solution of t-bhp and the aqueous solution of sodium formaldehyde sulfoxylate. The reaction was allowed to cool and stripped of most of the residual gases. The residual amount of vinyl chloride was determined and, if necessary, an additional aliquot of vinyl acetate was added to the storage vessel along with aliquots of aqueous sodium formaldehyde sulfoxylate and aqueous t-bhp. This process was repeated until the residual vinyl chloride level was below the required limit set by the Federal government. The solids were 52.2% with a viscosity of 226 cps at 60 rpm with a number 3 LV spindle. The T_{g} of the polymer was 12.0° C.

### EXAMPLE 2

### Testing of Synthetic Webs Effect of Vinyl Chloride on Vinyl Acetate-Ethylene Binders

In this example, nonwoven products employing polymers were prepared in accordance with the procedure of Example 1 with the exception of the composition of the polymer. The add-on weight of the polymer was 20 wt % of the nonwoven fibers. The fibers were comprised of carded polyester. The polymers were based upon a commercial, surfactant stabilized vinyl acetate/ethylene/N-methylol acrylamide polymer having about 85 wt % vinyl acetate, 12 wt % ethylene and 3 wt % of a 1:1 molar mixture of N-methylol acrylamide and acrylamide (labeled A-190 control). In preparing the polymers including vinyl chloride the level of vinyl acetate in A-190 was reduced by the amount of vinyl chloride monomer (VCM) added.

The performance of the polymers are summarized in the following histogram.

[image]

The order of bars in the histogram are the same as in the legend; i.e., A-190 control is the first bar; A-190+5% VCM is the second bar; A-190+10% VCM is the third bar; A-190+15% VCM is the fourth bar; and A-190+20% VCM is the last bar. The histogram shows that the performance of a nonwoven web or polyester fibers bonded with a vinyl acetate/ethylene/N-methylol acrylamide binder may be improved by the replacement of small amounts of vinyl acetate with vinyl chloride. Although there is some margin of error in the test procedure, the substitution of up to 10% by weight of the polymer with vinyl chloride resulted in a significant improvement in wet tensile.

### EXAMPLE 3

### Testing of Synthetic Webs Effect of Acrylates on Vinyl Acetate/Ethylene Binders

The procedure of Example 2 was followed except that the various acrylates were substituted for vinyl chloride. In the example EA refers to ethyl acrylate, BA refers to butyl acrylate and EHA refers to 2-ethylhexyl acrylate. The following histogram provides the results.

[image]

The order of bars in the histogram are the same as in the legend; i.e., A-190 control is the first bar; A-190 with EA is the second bar; A-190 with BA is the third bar; and A-190 with EHA is the last bar. The results show that polymerizing an acrylic monomer into the vinyl acetate/ethylene/NMA backbone does not afford an improvement in wet tensile as does vinyl chloride.

### EXAMPLE 4

### Vinyl Acetate/Ethylene/N-Methylol Acrylamide Based Binders

In this example, nonwoven products were prepared in accordance with the general procedures of Example 2 with the exception of the composition of the polymer employed. The add-on weight of the polymer was 20 wt % of the nonwoven fibers. The polymers were prepared based upon an emulsion polymerized commercial vinyl acetate/ethylene/N-methylol acrylamide polymer having about 78 wt % vinyl acetate, 18 wt % ethylene and 4 wt % N-methylol acrylamide (labeled A-105 control). In preparing the vinyl chloride based systems the level of vinyl acetate was reduced by the amount of vinyl chloride added.

In the example, A-105 refers to a surfactant stabilized emulsion based including an alkyl nonyl phenol ethoxylate as employed in Example 1 and A-177 is a commercial vinyl acetate/ethylene/NMA based binder emulsion but based upon an alkyl phenol ethoxylate free stabilizing system (APE free).

The results of the testing the effectiveness with respect to nonwoven products based upon polyester fibers is set forth in the following histograms:

[image]

The order of bars in the histogram are the same as in the legend; i.e., A-105 control is the first bar; and A-105+10% VCM is the second bar.

[image]

The order of bars in the histogram are the same as in the legend; i.e., A-105 control is the first bar; A-177 is the second bar; A-105+10% VCM is the third bar; and A117+10% VCM is the last bar. The histograms show the substantial enhancement of a vinyl acetate/ethylene/N-methylol acrylamide based binder in terms of wet tensile strength by the addition of vinyl chloride thus forming a vinyl acetate/ethylene/vinyl chloride/N-methylol acrylamide based binder.

What is claimed is:

1. In a nonwoven web comprised of loosely assembled fibers bonded together with a self crosslinking vinyl acetate/ethylene polymeric binder formed by emulsion polymerization, the improvement which comprises:
said web including synthetic fibers as a component of the web, and,
said self-crosslinking vinyl acetate/ethylene polymer comprising polymerized units of vinyl acetate, ethylene, vinyl chloride and one or more self-crosslinking monomers.

2. The nonwoven product of claim 1 wherein the self-crosslinking monomer is N-methylol acrylamide.

3. The nonwoven product of claim 2 wherein the vinyl chloride is present in an amount from 5 to 40 weight percent.

4 The nonwoven product of claim 3 wherein the ethylene is present in the polymer in an amount from 5 to 40 weight percent.

5. The nonwoven product of claim 4 wherein the vinyl acetate is present in an amount from 60 to 90 weight percent.

6. The nonwoven product of claim 5 wherein the vinyl chloride is present in an amount from 10 to 25 wt %.

7. The nonwoven product of claim 6 wherein the vinyl acetate is present in an amount from 70 to 80 wt %.

8. The nonwoven product of claim 7 wherein the ethylene is present in an amount from 10 to 25 wt %.

9. The nonwoven product of claim 8 wherein the N-methylol acrylamide is present in an amount from 3 to 8 wt %.

10. The nonwoven product of claim 9 wherein the synthetic fibers are selected from the group consisting of polyester, polyamide, polyacrylate, polyethylene, and polypropylene.

11. The nonwoven product of claim 10 wherein the self-crosslinking monomers are an equimolar mixture of N-methylol acrylamide and acrylamide.

12. A water-based emulsion polymerized polymer comprised of polymerized units of vinyl acetate, ethylene, vinyl chloride and one or more self-crosslinking monomers comprising N-methylol acrylamide, said vinyl acetate present in an amount form 60 to 90 wt %, said ethylene present in an amount from 5 to 40 wt %, said vinyl chloride present in an amount from 5 to 40 wt %, and said self-crosslinking monomers present in an amount from 2 to 10 wt %, based on the total weight of monomers.

13. The water-based emulsion polymerized polymer of claim 12 wherein the vinyl chloride is present in an amount from 10 to 25 wt %.

14. The water-based emulsion polymerized polymer of claim 13 wherein the vinyl acetate is present in an amount from 70 to 80 wt %.

15. The water-based emulsion polymerized polymer of claim 14 wherein the ethylene is present in an amount from 10 to 25 wt %.

16. The water-based emulsion polymerized polymer of claim 15 wherein the N-methylol acrylamide is present in an amount from 3 to 8 wt %.

17. The water-based emulsion polymerized polymer of claim 16 wherein the self-crosslinking monomers are an equimolar mixture of N-methylol acrylamide and acrylamide.
